(19) United States
(12) Patent Application Publication
(10) Pub. No.: US 2026/0260443 A1
(43) Pub. Date: Sep. 3, 2026

(54) AMBIENT LIGHT COMPENSATION METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Shaoming Wang, Shenzhen (CN); Jinkun Hou, Shenzhen (CN); Runzheng Guo, Shenzhen (CN)

(73) Assignee: TENCENT TECHNOLOGY (SHENZHEN) COMPANY LIMITED, Shenzhen (CN)

(21) Appl. No.: 19/655,206

(22) Filed: Apr. 22, 2026

Related U.S. Application Data
(63) Continuation of application No. PCT/CN2024/123621, filed on Oct. 9, 2024.

(30) Foreign Application Priority Data
Jan. 3, 2024 (CN) 202410026033.7

(51) Int. Cl. G06V 10/141; G06V 10/145; G06V 10/56; G06V 10/764; G06V 10/774

(52) U.S. Cl. CPC G06V 10/141; G06V 10/145; G06V 10/56; G06V 10/764; G06V 10/774

(57) ABSTRACT

An ambient light compensation method including: shooting an environment image based on a distance between an object and a distance sensor being less than a preset threshold, determining an original light color and a color cast value of a current ambient light based on color information in the environment image, the color cast value representing a color distribution status of the original light color in a color gamut, determining, based on the original light color and a target light color of a target ambient light, a compensation light color corresponding to the current ambient light, determining a light lightness adjustment parameter based on the compensation light color and the color cast value, and performing light compensation on the current ambient light based on the light lightness adjustment parameter.

### CROSS-REFERENCE TO RELATED APPLICATIONS

This application is a continuation application of International Application No. PCT/CN2024/123621 filed on Oct. 9, 2024, which claims priority to Chinese Patent Application No. 202410026033.7, filed with the China National Intellectual Property Administration on Jan. 3, 2024, the disclosures of each being incorporated by reference herein in their entireties.

### FIELD

The disclosure relates to the field of optoelectronic technologies, and in particular, to an ambient light compensation method and apparatus, an electronic device, a storage medium, and a program product.

### BACKGROUND

With continuous development of science and technology, payment methods also change continuously. Nowadays, electronic payment gradually comes into public view, and people can securely and quickly complete transactions through mobile phone code scanning, near field communication (NFC), face swiping, fingerprint swiping, palm print swiping, and the like. In payment manners of face swiping, fingerprint swiping, and palm print swiping, a transaction can be completed only by providing face information, fingerprint information, or palm print information in front of a corresponding electronic device without memorizing a password and using a device like a card or a mobile phone by the payer.

In a related technology, an electronic device may usually capture an image of a face, a fingerprint, or a palm print by using an image sensor, and then harmonize the captured image by using an image color adjustment model trained in advance, to adjust a background color of the captured image to a target color.

However, the image color adjustment model is usually trained based on a color of a fixed type of ambient light, and only has a good color adjustment capability for an captured image obtained in the fixed type of ambient light. If the ambient light changes, a color harmony effect thereof becomes poor, and an adjustment result outputted by the model for the original background color of the image deviates from the target color.

In conclusion, there is a need to improve an adjustment effect for ambient light.

### SUMMARY

The disclosure provides an ambient light compensation method and apparatus, an electronic device, a storage medium, and a program product, to improve ambient light compensation accuracy.

One or more embodiments provide an ambient light compensation method, performed by an electronic device, including: shooting an environment image based on a distance between an object and a distance sensor being less than a preset threshold; determining an original light color and a color cast value of a current ambient light based on color information in the environment image, the color cast value representing a color distribution status of the original light color in a color gamut; determining, based on the original light color and a target light color of a target ambient light, a compensation light color corresponding to the current ambient light; determining a light lightness adjustment parameter based on the compensation light color and the color cast value; and performing light compensation on the current ambient light based on the light lightness adjustment parameter.

One or more embodiments provide an ambient light compensation apparatus including: at least one memory configured to store program code; and at least one processor configured to read the program code and operate as instructed by the program code, the program code comprising: shooting code configured to cause at least one of the at least one processor to shoot an environment image based on a distance between an object and a distance sensor being less than a preset threshold; first determining code configured to cause at least one of the at least one processor to determine an original light color and a color cast value of a current ambient light based on color information in the environment image, the color cast value representing a color distribution status of the original light color in a color gamut; second determining code configured to cause at least one of the at least one processor to determine, based on the original light color and a target light color of a target ambient light, a compensation light color corresponding to the current ambient light; third determining code configured to cause at least one of the at least one processor to determine a light lightness adjustment parameter based on the compensation light color and the color cast value; and compensation code configured to cause at least one of the at least one processor to perform light compensation on the current ambient light based on the light lightness adjustment parameter.

One or more embodiments provide a non-transitory computer-readable storage medium, storing computer code which, when executed by at least one processor, causes the at least one processor to at least

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a logical schematic diagram of a training and application process of an image color adjustment model in a related technology according to one or more embodiments.

FIG. 2 is a schematic diagram of an application scenario of an ambient light compensation method according to one or more embodiments.

FIG. 3 is an overall flowchart of an ambient light compensation method according to one or more embodiments.

FIG. 4 is a schematic diagram of shooting an environment image according to one or more embodiments.

FIG. 5 is a top view of a lamp light compensation module according to one or more embodiments.

FIG. 6 is a schematic structural diagram of a semiconductor light emitting diode according to one or more embodiments.

FIG. 7 is a schematic diagram of three primary colors according to one or more embodiments.

FIG. 8 is a schematic diagram of ambient light compensation according to one or more embodiments.

FIG. 9 is an overall flowchart of another ambient light compensation method according to one or more embodiments.

FIG. 10 is a schematic structural composition diagram of an ambient light compensation apparatus according to one or more embodiments.

FIG. 11 is a schematic structural composition diagram of hardware of an electronic device according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some concepts in some embodiments are described below.

A light color is a color of light, and in one or more embodiments, is mainly classified into an original light color, a target light color, and a compensation light color. The original light color is an original color of current ambient light, the target light color is a color that is of ideal light, that needs to be reached, and that is preset based on a requirement, the compensation light color is a color of compensation light, and the compensation light is configured for compensation (or referred to as adjustment) on the current ambient light.

Color information is color information of a color image, and a specific value depends on used color spaces. When the color spaces are represented by channels, the color information is color information of an environment image on a plurality of channels, and is briefly referred to as color channel information, for example, values based on three color channels of red green blue (RGB), or values based on three channels of hue, saturation, and value (HSV).

The following briefly introduces design ideas of some embodiments.

With continuous development of science and technology, electronic devices gradually come into public view due to being convenient. The electronic devices may capture a human face, a fingerprint, or a palm print by using an image sensor and extract a feature therein, so as to recognize a person identity. Because ambient light is usually not in an ideal state (the ideal state is determined according to an actual situation, and may be, for example, white), to accurately extract a feature of a human face, a fingerprint, or a palm print, an image usually further needs to be processed, so that a background color of the image is close to a target background color.

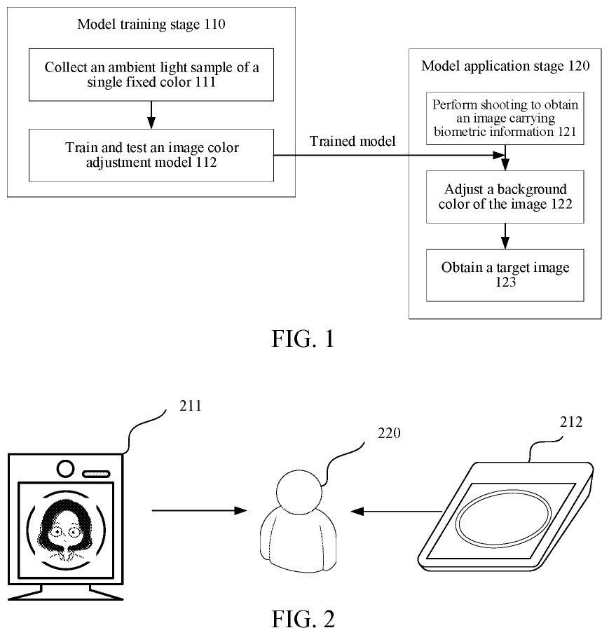

In a related technology, color harmonization is performed on a captured image usually by using a trained image color adjustment model, to adjust a background color of the captured image from an ambient color to a target color. FIG. 1 is a logical schematic diagram of a training and application process of an image color adjustment model in a related technology. The training and application process includes a model training stage 110 and a model application stage 120.

The early model training stage 110 includes:

Operation 111: Collect an ambient light sample of a single fixed color.

Operation 112: Train and test the image color adjustment model by using the collected ambient light sample, and adjust a model parameter, to obtain a trained image color adjustment model.

Then, the trained image color adjustment model is put into application. In the model application stage 120, the method includes:

Operation 121: Perform shooting to obtain an image carrying biometric information, such as a palm print image or a face image.

Operation 122: Adjust a background color of the image by using the trained image color adjustment model, to adjust the background color to a target color.

Operation 123: Output the image whose background color has been adjusted as a target image.

However, in this method, because the sample is an ambient light sample of a single fixed color, the trained image color adjustment model has a good color adjustment capability only for a captured image obtained in this fixed type of ambient light. If the ambient light changes, a color harmony effect thereof becomes poor, and an adjustment result outputted by the image color adjustment model for the original background color of the image deviates from the target color.

In view of this, one or more embodiments provide an ambient light compensation method and apparatus, an electronic device, a storage medium, and a program product to improve ambient light compensation accuracy. At least one lamp group is built in the electronic device, and can emit light of different colors. Therefore, compensation can be directly performed on ambient light and color adjustment is not performed on a shot image.

In one or more embodiments, when it is detected that an object comes near, a surrounding environment image is obtained, and color information in the image is analyzed to determine an original light color of the current ambient light. Further, a compensation light color that needs to be emitted by the lamp group is determined based on the original light color and a target light color, so as to adjust the ambient light.

In comparison with a manner of directly adjusting a color of a captured image by using an image color adjustment model, in the method according to one or more embodiments, a model does not need to be trained and a model parameter does not need to be adjusted, reducing processing overheads and reducing costs of ambient light compensation.

Further, the method provided in one or more embodiments is not limited by a training sample used in a model training process, in other words, a case in which there is a good adjustment effect only for a type of ambient light limited by the training sample does not occur. When the ambient light changes and adjustment deviates, corresponding compensation light can be accurately determined for ambient light of all colors, improving a color harmony effect.

In addition, in one or more embodiments, not only a light color of the compensation light is determined, but also lightness of the compensation light is further determined, and compensation is performed on the current ambient light in two aspects of hue and lightness of the light, so that a compensation result is more accurate. Assuming that the target light color is white, after the current ambient light is adjusted by using the compensation light, a background color of the shot image is closer to white.

The following describes one or more embodiments with reference to the accompanying drawings of the specification. The one or more embodiments described herein are merely intended to describe and explain the disclosure, but are not intended to be limited. In addition, one or more embodiments and features in the embodiments may be mutually combined without conflict.

FIG. 2 is a schematic diagram of an application scenario according to one or more embodiments. The application scenario diagram includes two biometric capture devices 211 and 212 and one capture object 220.

In one or more embodiments, the biometric capture device includes, but is not limited to, a face recognition device, a palm swiping device, a fingerprint recognition device, and the like. For example, 211 is the face recognition device, and 222 is the palm swiping device or the fingerprint recognition device. These biometric capture devices include a processor for biometric information capturing and ambient light compensation. For example, biometric information capturing may be performed on the capture object 220, and ambient light compensation is completed while the capturing is performed.

The ambient light compensation method according to one or more embodiments may be performed by an electronic device, that is, the method may be performed by the biometric capture device 211 or 212 alone. When the biometric capture device 211 or 212 is used as an execution body, the biometric capture device 211 or 212 shoots an environment image when detecting that a distance between the object and a distance sensor is less than a preset threshold, to determine an original light color and a color cast value of current ambient light based on color information in the environment image. Then, the biometric capture device 211 or 212 determines, based on the original light color and a preset target light color of target ambient light, a compensation light color of compensation light corresponding to the current ambient light. Further, the biometric capture device 211 or 212 determines light lightness of the compensation light based on the compensation light color and the color cast value, and finally performs light compensation on the current ambient light by using the compensation light.

FIG. 2 is merely exemplary. A quantity of biometric capture devices 211 or 212 and a quantity of capture objects are not limited thereto.

In addition, one or more embodiments may be applied to various scenarios, not only including a biometric information capture scenario, but also including but not limited to scenarios of cloud technologies, artificial intelligence, intelligent transportation, assisted driving, and the like.

The following describes the ambient light compensation method according to one or more embodiments with reference to the foregoing described application scenarios and with reference to the accompanying drawings. The foregoing application scenarios are merely shown for ease of understanding the spirit and principle of this disclosure, and the implementations of this disclosure are not limited in this aspect.

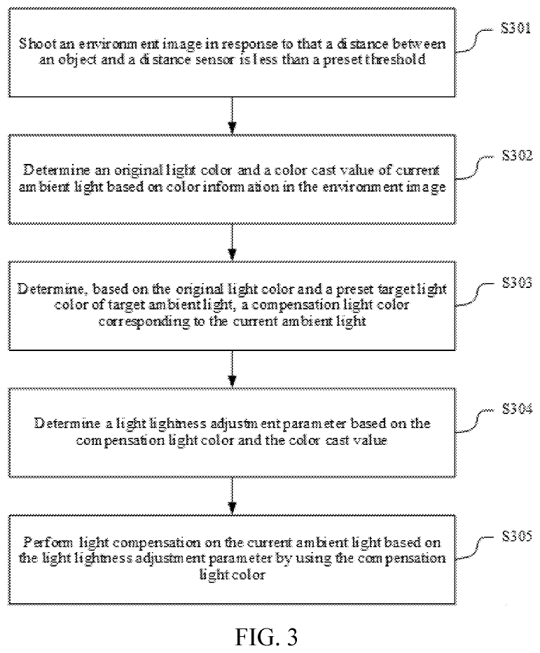

FIG. 3 is a flowchart of implementation of an ambient light compensation method according to one or more embodiments. The method is performed by an electronic device, for example, the biometric capture device 211 or 212 shown in FIG. 2. A specific implementation procedure of the method is as follows:

S301: Shoot an environment image in response to that a distance between an object and a distance sensor is less than a preset threshold.

Different electronic devices may separately capture different information such as fingerprints, palm prints, and human faces, and the captured information may be configured for many aspects such as identity authentication, payment, and clocking in.

Descriptions are provided mainly by using a palm swiping device for capturing a palm print as an example. However, the method according to one or more embodiments is not only applicable to the palm swiping device, and another electronic device meeting a condition is also applicable.

In one or more embodiments, the object may be an object like a palm of a user, a face of a user, or a card. The electronic device includes a distance sensor. When sensing that a distance between the distance sensor and an object reaches a pre-determined range, for example, the distance is less than a preset threshold, the distance sensor may trigger a signal for triggering a camera module in the electronic device to shoot an environment image.

The foregoing distance sensor may be an infrared distance sensor. The sensor may use an infrared ray to detect a distance and capture data of the distance from an object to the sensor, or may be an ultrasonic distance sensor, or the like. For example, a model of the infrared distance sensor is GP2Y0A21YK0F, or the like. The camera module may be a camera or the like, and this is not specifically limited herein.

In an example, the preset threshold may be set to a distance range, including [minimum distance, maximum distance]. The minimum distance defines that the palm is not excessively close to the electronic device (for example, the palm swiping device), and the maximum distance defines that the palm is not excessively far from the palm swiping device, to ensure that environment information in a range near the palm is obtained through shooting.

In another example, the preset threshold may be set to a distance threshold. The distance threshold is usually large, for example, greater than 10 cm or 15 cm, to trigger shooting when the palm is far from the palm swiping device, so as to obtain environment information through shooting as much as possible. In this way, it is prevented that the palm is excessively close to the camera module and covers most environment information. Setting of the foregoing preset threshold is merely an example, and adjustment may be performed based on a specific situation during actual setting. This is not specifically limited herein.

In one or more embodiments, to ensure that a light compensation policy is most timely and effective, a logical timing of triggering light compensation is that image capture, analysis, and light compensation are performed when an object comes near.

Using a specific scenario as an example, it is assumed that a shopping mall has a palm swiping device, configured to determine an identity of a palm swiping object by recognizing a palm print, to further complete a payment function. When the distance sensor detects that an object comes near and a distance gradually decreases until a preset threshold is met, the camera module shoots a surrounding environment, to obtain an environment image.

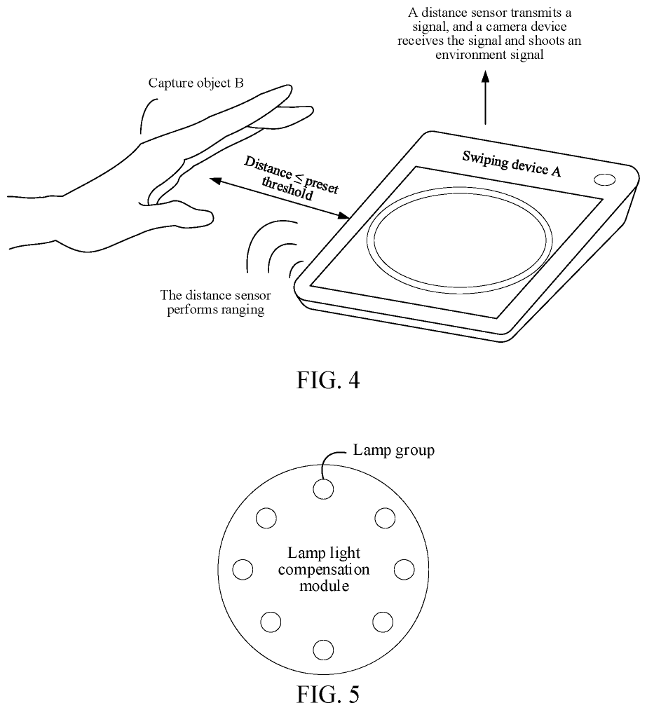

Using an actual scenario as an example, FIG. 4 is a schematic diagram of shooting an environment image according to one or more embodiments. It is assumed that currently there is a palm swiping device Ain a shopping mall. A capture object B performs palm swiping payment by using the palm swiping device A. A distance sensor built in the palm swiping device A is responsible for ranging. When the distance sensor detects that an object (a palm of the capture object B) comes near and a distance gradually decreases to be less than or equal to a preset threshold, the distance sensor transmits a trigger signal to a camera module, to trigger the camera module to shoot an environment image.

In one or more embodiments, the shot environment image may include the object or may not include the object. However, when the environment image includes the object, because the object is far away, the environment image includes only a part of the object or the object that is vague.

S302: Determine an original light color and a color cast value of current ambient light based on color information in the environment image.

The color information includes a plurality of pieces of color channel information, for example, values of pixels in the environment image on RGB color channels, or values of the pixels on HSV channels.

To better adapt to a local color change in the environment image, a processor in an electronic device may divide the environment image into a plurality of image areas, and calculate the original light color based on the areas. For example, the environment image is divided into 8×8 areas, 16×16 areas, or the like, which may be determined based on a specific situation.

Then, the electronic device determines, for each image area based on the plurality of pieces of color channel information of pixels in the image area, a local color temperature value corresponding to the image area; and determines, based on local color temperature values respectively corresponding to the image areas, an overall color temperature value corresponding to the environment image, the overall color temperature value representing the original light color.

In some embodiments, an example in which the color information is values on the RGB color channels is used. For an area in the environment image, values on the RGB color channels corresponding to each pixel may be obtained by using a method like getPixel( ) of a Bitmap class. Then, an average value R⁻ of the red color channel, an average value G⁻ of the green color channel, and an average value B⁻ of the blue color channel of all pixels in the area are calculated.

Further, a calculation formula of a local color temperature value of the area is as follows:

$$Local color temperature value = ( {R}^{-} + {G}^{-} + {B}^{-} ) / 3$$

Then, an average value of local color temperature values of all areas may be taken, to obtain the overall color temperature value corresponding to the environment image, representing the original light color of the current ambient light.

Besides, color channel information may further be converted between different channels, and a color temperature value is calculated by using converted color channel information. For example, color channel information on RGB is converted into color channel information on three channels of lightness, red-green, and yellow-blue, or three channels of HSV Then, a local color temperature value corresponding to each image area is calculated based on a lightness value, to obtain the overall color temperature value corresponding to the environment image.

In the foregoing processing, after the environment image is divided into the plurality of image areas, the local color temperature values are calculated based on the areas, and then an average value is taken to obtain the overall color temperature value, so that the determined original light color may be more accurate.

Similar to calculating a color temperature value, to make an obtained color cast value more accurate, division into areas also needs to be performed for obtaining the color cast value. The color cast value represents a color distribution status of an original light color in a color gamut, and may also be referred to as a color deviation.

In some embodiments, the processor of the electronic device divides the environment image into the plurality of image areas; determines, for each image area based on a difference that is between a plurality of color channels and that is of the plurality of pieces of color channel information of the pixels in the image area, a local color cast value corresponding to the image area; and determines the color cast value of the current ambient light based on local color cast values respectively corresponding to the image areas.

In some embodiments, values on RGB color channels are still used as an example. For an area in the environment image, an average value R of the red color channel, an average value G of the green color channel, and an average value B of the blue color channel of all pixels in the area are calculated. Then, a difference between two color channels is calculated, and further, a formula for calculating a local color cast value is as follows:

$$Local color cast value = \sqrt{( ( {( {R}^{-} - {G}^{-} )}^{⋀} 2 + {( {G}^{-} - {B}^{-} )}^{⋀} 2 + {( {B}^{-} - {R}^{-} )}^{⋀} 2 ) / 3 )}$$

Then, an average value of local color cast values of all areas may be taken, to obtain the overall color cast value corresponding to the environment image, that is, the color cast value of the current ambient light.

In addition, in addition to determining the original light color of the current ambient light by using the color temperature value, a reference light color may also be determined based on a method of collecting statistics on pixel colors, where the reference light color may also reflect a color of the current ambient light to some extent.

In one or more embodiments, for each pixel in the environment image, the electronic device determines, based on color information of the pixel, a pixel color temperature value and/or a pixel color cast value corresponding to the pixel; aggregates pixels belonging to one interval into one pixel group based on the pixel color temperature value and color temperature value intervals obtained through division in advance, and/or the pixel color cast value and color cast value intervals obtained through division in advance; and determines a reference light color of the current ambient light based on a quantity of pixels in each pixel group and a color classification corresponding to each pixel group.

Each color temperature value interval corresponds to one color classification, and each color cast value interval corresponds to one color classification.

Using a color temperature value as an example, the electronic device obtains a pixel color temperature value corresponding to each pixel in the environment image; and aggregates pixels belonging to the same interval into a pixel group based on the pixel color temperature value and color temperature value intervals obtained through division in advance. For example, three groups may be obtained through division: red, green, and blue. Each group corresponds to one color temperature value interval. In this way, each color temperature value interval corresponds to one color. Then, a quantity of pixels in each pixel group is calculated, and a color corresponding to a group with a largest quantity of pixels is used as the reference light color corresponding to the current ambient light. For example, if a quantity of pixels in a red group accounts for 50% or more of a total quantity of pixels, it may be determined that red is used as the reference light color, where the reference light color may also reflect the color of current ambient light.

The reference light color is mainly determined through ratio counting, and may be used as a reference, to be compared with the original light color determined by using the color temperature value, so as to ensure that a difference between the original light color determined by using the color temperature value and the reference light color falls within a particular range. In this way, the original light color obtained by using the color temperature value may be adjusted to some extent based on the reference light color, so that compensation accuracy is higher.

The foregoing color grouping case is only an example for description, and specific grouping may be adjusted based on an actual requirement, and is not specifically limited herein.

The assumption in S301 is still used. After obtaining the environment image through shooting, the palm swiping device A performs area division on the environment image based on a size, like a length and a width, of the environment image. It is assumed that a total of 8×8, namely, 64 areas are obtained through division. For each area, a local color temperature value and a local color cast value of the corresponding area are obtained based on an average value R⁻ of a red color channel, an average value G⁻ of a green color channel, and an average value B⁻ of a blue color channel of pixels in the area. An average value of 64 local color temperature values is taken to obtain the overall color temperature value, and an average value of the 64 local color cast values is taken to obtain the overall color cast value.

S303: Determine, based on the original light color and a preset target light color of target ambient light, a compensation light color corresponding to the current ambient light.

The target light color is an ideal light color preset based on a specific requirement. Generally, biometric information can be more precisely extracted from an image obtained through shooting in the specified target light color of the target ambient light. However, there is a difference between the original light color of the current ambient light and the ideal light color due to reasons such as being affected by an external ambient, for example, warm lamp light being around, or light in a room being insufficient or dim. Therefore, adjustment or compensation needs to be performed on the current ambient light by using compensation light, so that the target light color of the target ambient light can be achieved by adding a compensation light color of the compensation light to the original light color of the current ambient light.

In one or more embodiments, the processor of the electronic device determines a compensation color temperature value based on a difference between the overall color temperature value corresponding to the original light color and a target color temperature value corresponding to the target light color, the compensation color temperature value representing the compensation light color.

In some embodiments, a specific calculation formula of the compensation color temperature value is as follows: Compensation color temperature value=Overall color temperature value−Target color temperature value. The target color temperature value indicates a white balance color temperature that is expected to be reached. Then, the compensation light color of the compensation light is determined based on the compensation color temperature value.

The electronic device according to one or more embodiments includes a lamp light compensation module. FIG. 5 is a top view of a lamp light compensation module according to one or more embodiments. The lamp light compensation module includes at least one lamp group. As shown in the figure, eight lamp groups are included. A plurality of semiconductor light emitting diodes (LEDs) are built in each lamp group, and include at least one red LED, at least one green LED, and at least one blue LED. Compensation light of different colors may be obtained by adjusting quantities or ratios of light emission of LEDs of different colors.

After the compensation color temperature value of the compensation light is obtained, the electronic device triggers the lamp light compensation module, and controls the quantities of the light emission of the LEDs of the different colors based on the compensation color temperature value, so that the lamp light compensation module emits the corresponding compensation light.

In addition to the foregoing method in FIG. 5 in which the eight lamp groups are included and each lamp group includes the plurality of LEDs, eight LED lamp balls may be directly placed in the lamp light compensation module, where each LED lamp ball has two pins: a positive pin and a negative pin. Each LED lamp ball is encapsulated by using transparent resin. A plurality of LED chips are encapsulated in each LED lamp ball, to control color changing on a plurality of color channels. For example, three LED chips are used, and color changing of three colors of red, green, and blue may be implemented by direct power-on. In one or more embodiments, a semiconductor element for controlling color changing is built in each LED lamp ball, to control color changing of three colors of red, green, and blue.

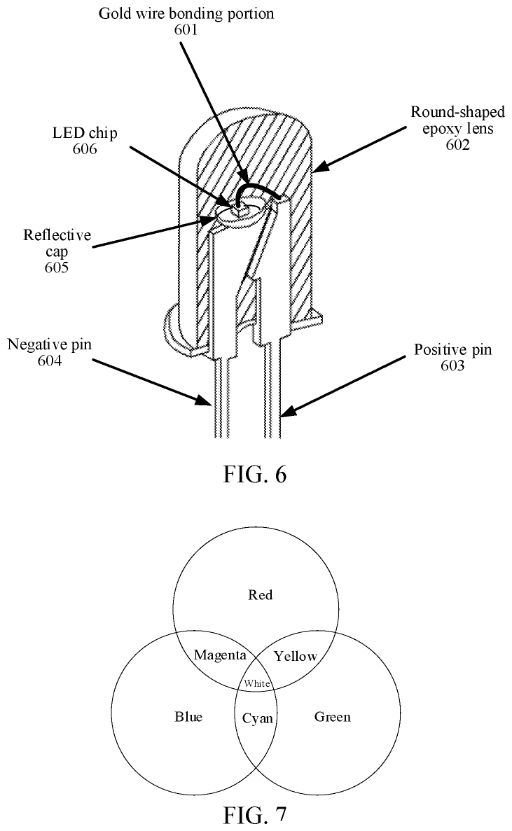

FIG. 6 is a schematic structural diagram of a semiconductor light emitting diode according to one or more embodiments. The semiconductor light emitting diode is a LED, and is a light emitting device that is made of a semiconductor material and that directly converts electric energy into light energy and an electric signal into an optical signal. The semiconductor light emitting diode mainly includes a gold wire bonding portion 601, a round-shaped epoxy lens 602, a positive pin 603, a negative pin 604, a reflective cap 605, and a LED chip 606.

In an embodiment, the original light color obtained by using a color temperature may be adjusted to some extent based on the reference light color of the current ambient light, so that compensation accuracy is higher. In other words, the electronic device may determine, based on the reference light color, the original light color, and the preset target light color of the target ambient light, the compensation light color corresponding to the current ambient light.

In some embodiments, the overall color temperature value of the original light color is adjusted based on the reference color temperature value of the reference light color, and then the compensation color temperature value of the compensation light color is obtained based on an adjusted overall color temperature value and the target color temperature value of the target light color. For example, when a difference between the reference color temperature value and the overall color temperature value is outside a preset range, an average value of the reference color temperature value and the overall color temperature value is determined as the adjusted overall color temperature value.

In another embodiment, after the compensation light color is determined based on the original light color and the target light color, a reference compensation color is determined by using the reference light color, and the reference compensation color is used as a reference for the compensation light color. In other words, adjustment is performed from a perspective of compensation, and the compensation color temperature value of the compensation light color is adjusted by using the reference color temperature value of the reference light color, to obtain an adjusted compensation color temperature value to represent the compensation light color.

When the reference compensation color is determined, an obtaining principle is performing addition or subtraction between light of different colors to obtain white light. There are the following two cases:

Case 1: Additive color mixing is performed on three primary colors, that is, the white light is obtained according to an additive color mixing principle of the three primary colors.

FIG. 7 is a schematic diagram of three primary colors according to one or more embodiments. Because only a black and white image can be presented, each color is marked in the figure in a form of a text. The three primary colors are red, green, and blue. Red and green are mixed in a 1:1 ratio to obtain yellow, red and blue are mixed in a 1:1 ratio to obtain magenta (a color between red and purple), blue and green are mixed in a 1:1 ratio to obtain cyan, and red, green, and blue are mixed in a 1:1:1 ratio to obtain white, that is, white light may be obtained by adding light of the three primary colors of red, green, and blue.

Therefore, when the reference light color includes a plurality of colors, ratios of LED lamps of the three colors of red, green, and blue may be controlled according to such an additive color mixing principle of the three primary colors, and corresponding light is emitted; and the white light can be obtained by superimposing light of the three colors and the current ambient light. Then, a combination of the three colors is the reference compensation color.

Case 2: Subtractive color mixing is performed on complementary colors, that is, the white light is obtained according to a subtractive color mixing principle of the complementary colors.

The white light may be obtained through subtraction between light of complementary colors. Blue and yellow are used as an example. Blue and yellow are complementary colors. A ratio between a needed blue LED to a needed yellow LED is calculated based on the previously obtained reference light color of the current ambient light, and based on this, corresponding LEDs are controlled to emit light. The target light color may be obtained by subtracting yellow light from blue light.

Therefore, when the reference light color includes a single color, a LED lamp of another hue is controlled, and when light of another hue phase overlaps current the ambient light, white light may be obtained. In this case, a color of the another hue is the reference compensation color.

S304: Determine a light lightness adjustment parameter based on the compensation light color and the color cast value.

S305: Perform light compensation on the current ambient light based on the light lightness adjustment parameter by using the compensation light color.

To make an effect of light compensation more natural and improve accuracy of ambient light compensation, in one or more embodiments, not only the compensation light color of the compensation light needs to be determined, but also lightness of the compensation light may be further determined based on the local color cast values of the areas in the environment image.

According to one or more embodiments, the processor of the electronic device determines a compensation ratio based on the local color cast values; and determines the light lightness adjustment parameter based on the compensation ratio and a compensation color temperature value corresponding to the compensation light color, the compensation color temperature value being determined based on the overall color temperature value corresponding to the original light color and a target color temperature value corresponding to the preset target light color of the target ambient light.

In some embodiments, for an area in the environment image, a difference between a local color cast value of the area and a largest local color cast value in all the areas is determined as a local deviation between the local color cast value of the area and the largest local color cast value, then an average value of obtained local deviations respectively corresponding to the areas is taken to obtain an overall deviation, and finally the overall deviation is used as the compensation ratio.

Further, the compensation ratio may be multiplied by the compensation color temperature value, to obtain the light lightness adjustment parameter. The compensation light color is configured for determining a color of the compensation light, and the light lightness adjustment parameter is configured for determining the lightness of the compensation light, that is, light-emitting lightness of a LED in the electronic device. In some embodiments, a duty ratio of a pulse width modulation signal may be determined by using the light lightness adjustment parameter, to adjust a current or voltage parameter, thereby further adjusting the lightness of the LED.

Finally, the processor of the electronic device enables the lamp light compensation module to emit the compensation light by controlling the quantities of the light emission of the LEDs of the different colors and controlling the light-emitting lightness (that is, light-emitting intensity) of the LEDs based on the light lightness adjustment parameter.

In addition, the solution described in the foregoing is mainly that before the capture object comes near the electronic device and information about the object is captured, a sensor transmits a signal to enable the camera module to shoot an environment image, so as to trigger a compensation process, that is, light compensation lamps of different colors/quantities are scheduled in parallel to harmonize current imaging, to generate an imaging effect having a highest degree of matching with the current environment, and resolve a problem that different ambient lamp light affects a recognition effect.

In addition, a periodicity may be preset, so that the electronic device periodically detects the ambient light and obtains the original light color, the compensation light color, and the light lightness adjustment parameter at each detection moment; and then, adjusts the light lightness adjustment parameter and the compensation light color at a current detection moment based on a difference between the original light color at the current detection moment and the original light color at a previous detection moment.

The preset periodicity may be set by collecting statistics on a change frequency of the original light color in the environment. When a value of the periodicity is short enough, once a change of the original light color of the current ambient light is detected, the compensation light is adjusted, to implement adaptive compensation.

The assumption in S303 is still used. After obtaining the compensation light color, specifically the compensation color temperature value, of the compensation light, the palm swiping device A further determines the lightness of the compensation light with reference to the color cast value. In some embodiments, the palm swiping device A uses an average value of differences between local color cast values of all areas and a largest local color cast value in all the areas as the compensation ratio, and multiplies the compensation ratio by the compensation color temperature value, to obtain the light lightness adjustment parameter. The light lightness adjustment parameter may be configured for adjusting a current or a voltage of a lamp group, to adjust lightness of a LED. Finally, a processor of the palm swiping device A enables a lamp light compensation module to emit the compensation light by controlling quantities of light emission of LEDs of different colors and controlling light-emitting lightness (that is, light-emitting intensity) of the LEDs based on the light lightness adjustment parameter, After compensation is performed on the current ambient light by using the compensation light, a background color of an image that is shot by the palm swiping device A is white.

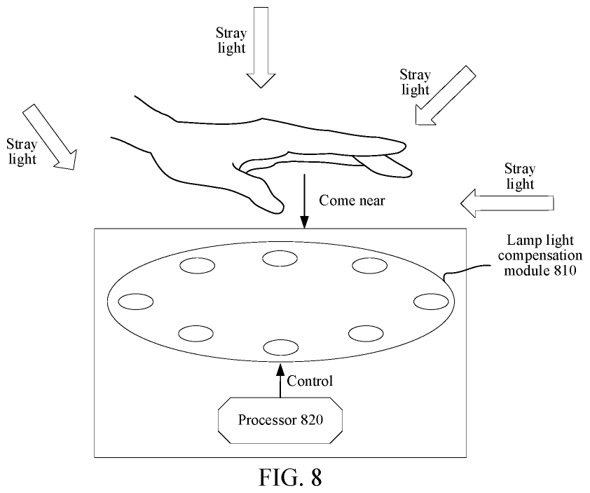

FIG. 8 is a schematic diagram of ambient light compensation according to one or more embodiments. An original light color of ambient light is usually different from a target light color due to impact by stray light. When it is detected that a palm comes near, an environment image is shot in advance. As shown in FIG. 4, current ambient light is captured from therein. Then, a processor 820 of an electronic device controls, based on an original light color of the current ambient light (including various stray light), a lamp light compensation module 810 to emit compensation light configured for adjusting the current ambient light. A target light color may be accurately obtained by superimposing the original light color of the current ambient light and a compensation light color of the compensation light. For example, LED lamp balls of different colors are disposed to harmonize the ambient light to become white light, thereby reducing interference to the electronic device when the electronic device performs biometric information recognition.

In conclusion, according to one or more embodiments, a background color (that is, a target light color) of palm swiping may be uniformly set. It is assumed that the background color is set to white. Before a capture object performs palm swiping, the capture object enables a palm to come near a device. When a distance sensor in the device detects that an object comes near and a distance is less than a preset threshold, a camera module quickly captures an environment image. A processor analyzes current ambient light in the image, adjusts a color and lightness of light emission of a lamp group with reference to a color neutralization policy, to perform compensation on the current ambient light, so that a background color of an image obtained through shooting is white, thereby reducing an image interference factor, and further improving recognition accuracy of the palm swiping.

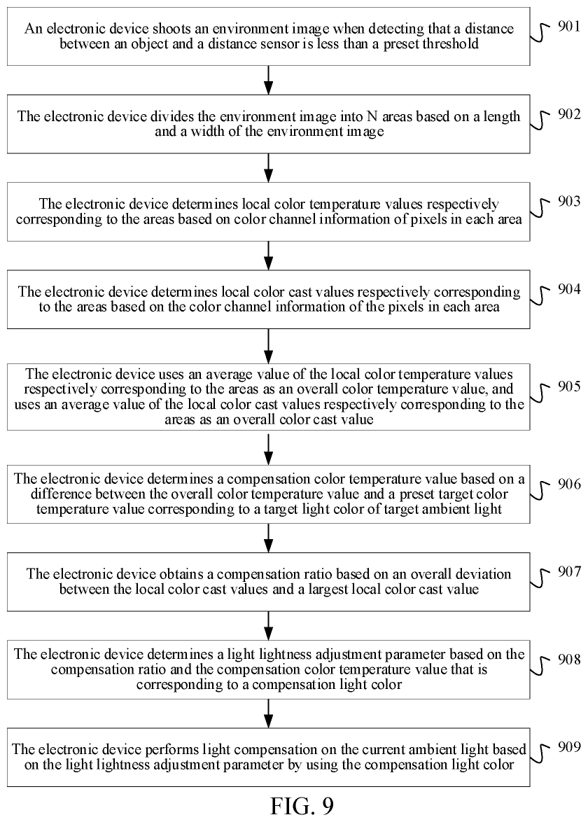

Next, a flowchart of another ambient light compensation method according to one or more embodiments is described. In one or more embodiments, S301 to S305 may be implemented according to the flowchart shown in FIG. 9, and are performed by an electronic device, for example, the biometric capture device 211 or 212 in FIG. 2. The following operations are included:

S901: The electronic device shoots an environment image when detecting that a distance between an object and a distance sensor is less than a preset threshold.

The distance sensor in the electronic device transmits a signal to a processor, and after receiving the signal, the processor controls a camera module to shoot the environment image.

S902: The electronic device divides the environment image into N areas based on a length and a width of the environment image.

S903: The electronic device determines local color temperature values respectively corresponding to the areas based on color channel information of pixels in each area.

In some embodiments, the electronic device separately obtains an average value R⁻ of a red color channel, an average value G⁻ of a green color channel, and an average value B⁻ of a blue color channel of each pixel in each area, and further uses an average value of R⁻, G⁻, and B⁻ as a local color temperature value of the corresponding area.

S904: The electronic device determines local color cast values respectively corresponding to the areas based on the color channel information of the pixels in each area.

For example, a local color cast value of an area is obtained based on an average value R⁻ of a red color channel, an average value G⁻ of a green color channel, and an average value B⁻ of a blue color channel of pixels in the area.

S905: The electronic device uses an average value of the local color temperature values respectively corresponding to the areas as an overall color temperature value, and uses an average value of the local color cast values respectively corresponding to the areas as an overall color cast value.

S906: The electronic device determines a compensation color temperature value based on a difference between the overall color temperature value and a preset target color temperature value corresponding to a target light color of target ambient light.

S907: The electronic device obtains a compensation ratio based on an overall deviation between the local color cast values and a largest local color cast value.

S908: The electronic device determines a light lightness adjustment parameter based on the compensation ratio and the compensation color temperature value that is corresponding to a compensation light color.

The compensation ratio is multiplied by the compensation color temperature value, to obtain the light lightness adjustment parameter, which is a lightness value.

S909: The electronic device performs light compensation on the current ambient light based on the light lightness adjustment parameter by using the compensation light color.

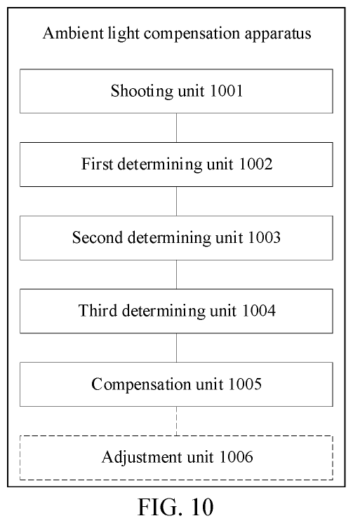

Based on the same inventive concept, one or more embodiments provide an ambient light compensation apparatus. FIG. 10 is a schematic structural diagram of an ambient light compensation apparatus. The ambient light compensation apparatus may include:
a shooting unit 1001, configured to shoot an environment image in response to that a distance between an object and a distance sensor is less than a preset threshold;
a first determining unit 1002, configured to determine an original light color and a color cast value of current ambient light based on color information in the environment image, the color cast value representing a color distribution status of the original light color in a color gamut;
a second determining unit 1003, configured to determine, based on the original light color and a preset target light color of target ambient light, a compensation light color corresponding to the current ambient light;
a third determining unit 1004, configured to determine a light lightness adjustment parameter based on the compensation light color and the color cast value; and
a compensation unit 1005, configured to perform light compensation on the current ambient light based on the light lightness adjustment parameter by using the compensation light color.

In some embodiments, the color information includes a plurality of pieces of color channel information, and the first determining unit 1002 is configured to determine the original light color of the current ambient light in the following manner:
dividing the environment image into the plurality of image areas;
determining, for each image area based on the plurality of pieces of color channel information of pixels in the image area, a local color temperature value corresponding to the image area; and
determining, based on local color temperature values respectively corresponding to the image areas, an overall color temperature value corresponding to the environment image, the overall color temperature value representing the original light color.

In some embodiments, the color information includes a plurality of pieces of color channel information, and the first determining unit 1002 is configured to determine the color cast value of the current ambient light in the following manner:
dividing the environment image into the plurality of image areas;
determining, for each image area based on a difference that is between a plurality of color channels and that is of the plurality of pieces of color channel information of the pixels in the image area, a local color cast value corresponding to the image area; and
determining the color cast value of the current ambient light based on local color cast values respectively corresponding to the image areas.

In some embodiments, the second determining unit 1003 is configured to determine a compensation color temperature value based on a difference between the overall color temperature value and a target color temperature value corresponding to the target light color, the compensation color temperature value representing the compensation light color.

In some embodiments, the third determining unit 1004 is configured to: determine a compensation ratio based on the local color cast values; and determine the light lightness adjustment parameter based on the compensation ratio and a compensation color temperature value corresponding to the compensation light color, the compensation color temperature value being determined based on the overall color temperature value corresponding to the original light color and a target color temperature value corresponding to the target light color.

In some embodiments, the first determining unit 1002 is further configured to: determine, for each pixel in the environment image based on color information of the pixel, a pixel color temperature value and/or a pixel color cast value corresponding to the pixel; aggregate pixels belonging to one interval into one pixel group based on the pixel color temperature value and color temperature value intervals obtained through division in advance, and/or the pixel color cast value and color cast value intervals obtained through division in advance; and determine a reference light color of the current ambient light based on a quantity of pixels in each pixel group and a color classification corresponding to each pixel group.

The second determining unit 1003 is further configured to determine the compensation light color based on the reference light color, the original light color, and the target light color.

In some embodiments, the apparatus further includes:
an adjustment unit 1006, configured to: periodically detect ambient light, to obtain the original light color, the compensation light color, and the light lightness adjustment parameter at each detection moment; and adjust the light lightness adjustment parameter and the compensation light color at a current detection moment based on a difference between the original light color at the current detection moment and the original light color at a previous detection moment.

For ease of description, the foregoing parts are divided into modules (or units) based on functions for respective description. Certainly, the functions of the modules (or units) may be implemented in one or more pieces of software or hardware.

In some embodiments, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

After the ambient light compensation method and apparatus according to one or more embodiments are described, next, an electronic device according to one or more embodiments is described.

Persons skilled in the art can understand that aspects of this disclosure may be implemented as a system, a method, or a program product. Therefore, each aspect of this disclosure may be implemented in the following form: an implementation of complete hardware, an implementation of complete software (including firmware, micro code, and the like), or an implementation of a combination of hardware and software, which may be uniformly referred to as “circuit”, “module”, or “system” herein.

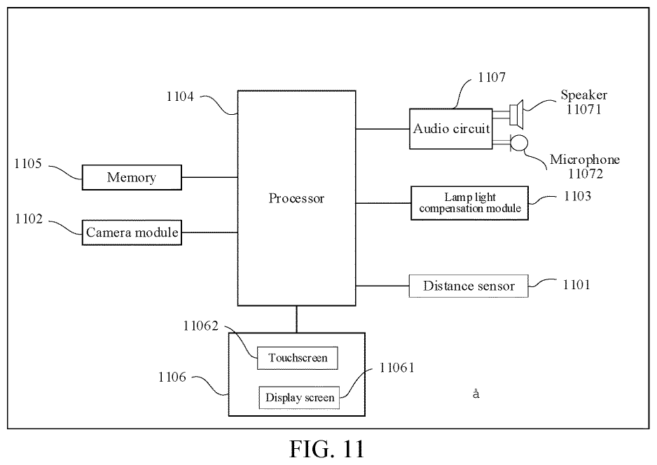

Based on the same inventive concept as the foregoing method embodiments, one or more embodiments further provides an electronic device. In an embodiment, the electronic device may be an electronic device like a palm swiping device, a fingerprint recognition device, or a face recognition device, or may be another device with a biometric information capture function. In one or more embodiments, a structure of the electronic device may be shown in FIG. 11, and includes components such as a distance sensor 1101, a camera module 1102, a lamp light compensation module 1103, a processor 1104, a memory 1105, a display unit 1106, and an audio circuit 1107.

The distance sensor 1101 is configured to perform ranging, and transmit a signal to the processor 1104 once detecting that an object comes near and a distance is less than a preset threshold. After receiving the signal, the processor 1104 controls the camera module 1102 to shoot an environment image.

The camera module 1102 may be a camera or the like, and there may be one or more cameras. An optical image of the object is generated through a lens and is projected to a photosensitive element. The photosensitive element may be a charge coupled device (CCD) or complementary metal-oxide-semiconductor (CMOS) phototransistor. The photosensitive element converts an optical signal into an electrical signal and then transfers the electrical signal to the processor 1104 to be converted into a digital image signal.

The lamp light compensation module 1103 is configured to emit needed compensation light. In some embodiments, the processor 1104 determines a light emission ratio between red, blue, and green LED lamps in the lamp light compensation module 1103 based on a compensation color temperature value of the obtained compensation light and a light lightness adjustment parameter, and adjusts a current or a voltage based on the light lightness adjustment parameter to control lightness of the LED lamps, so as to enable the lamp light compensation module 1103 to emit the compensation light.

The memory 1105 may be configured to store a software program and data. The processor 1104 runs the software program or data stored in the memory 1105, to execute various functions of the physical terminal device 1100 and process the data. The memory 1105 may include a high speed random access memory, and may include a non-volatile memory, such as at least one magnetic disk storage device, a flash memory, or another volatile solid-state storage device.

Some electronic devices further include a display unit 1106 and an audio circuit 1107, for example, a face swiping device and a sound recognition device. The display unit 1106 may be configured to display information inputted by an object or information provided for an object, and a graphical user interface (GUI) of various menus of the electronic device 1100. The display unit 1106 may include a display screen 11061 disposed on a front of the electronic device 1100. The display screen 11061 may be disposed in a form of a liquid crystal display (LCD), an organic light emitting diode (OLED), or the like. The display unit 1106 may be configured to display a training interface of an image color adjustment model, and the like in one or more embodiments.

The display unit 1106 may further be configured to: receive inputted digit or character information, and generate a signal input associated with object setting and function control of the electronic device 1100. In some embodiments, the display unit 1106 may include a touchscreen 11062 disposed on the front of the electronic device 1100, and the touchscreen 11062 may collect a touch operation that is performed by the object on or near the touchscreen 11062, for example, tapping a button and dragging a scroll box.

The touchscreen 11062 may cover the display screen 11061, or the touchscreen 11062 and the display screen 11061 may be integrated to implement an input function and an output function of the electronic device 1100. The touchscreen 11062 and the display screen 11061 that have been integrated may be referred to as a touch display screen. The display unit 1106 may display an application program and a corresponding operating operation.

The audio circuit 1107, a speaker 11071, and a microphone 11072 may provide an audio interface between the object and the electronic device 1100. The audio circuit 1107 may transmit an electric signal converted from received audio data to the speaker 11071. The speaker 11071 converts the electric signal into a sound signal and outputs the sound signal. A volume button may be further disposed on the electronic device 1100, to adjust a volume of the sound signal. In addition, the microphone 11072 converts a collected sound signal into an electrical signal, the audio circuit 1107 receives the electrical signal, converts the electrical signal into audio data, and then outputs the audio data, or outputs the audio data to the memory 1105 for further processing.

The processor 1104 is a control center of the electronic device 1100, is connected to various parts of the entire electronic device 1100 by using various interfaces and lines, and by running or executing the program stored in the memory 1105 and invoking the data stored in the memory 1105, implements various functions of the electronic device and processes the data. In some embodiments, the processor 1104 may include one or more processing units. The processor 1104 may be further integrated with an application processor and a baseband processor. The application processor mainly processes an operating system, a user interface, an application program, and the like. The baseband processor mainly processes wireless communication. The above baseband processor may either not be integrated into the processor 1104. The processor 1104 may run the operating system and the application program, and perform user interface display, touch responding, and an image color adjustment model training method in one or more embodiments. In addition, the processor 1104 is coupled to the display unit 1106.

In some embodiments, the aspects of the ambient light compensation method may further be implemented in a form of a program product including a computer program. When the program product is run on the electronic device, the computer program is configured to cause the electronic device to perform the operations of the ambient light compensation method according to the exemplary implementations of this application described above in this specification. For example, the electronic device may perform the operations shown in FIG. 3.

The program product may use any combination of one or more readable media. The readable medium may be a readable signal medium or a readable storage medium. The readable storage medium may be, for example, but is not limited to, an electric, magnetic, optical, electromagnetic, infrared, or semi-conductive system, apparatus, or device, or any combination thereof. More specific examples (a non-exhaustive list) of the readable storage medium include an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof.

The program product according to some embodiments may use a portable compact disc read-only memory (CD-ROM), include the computer program, and may be run on the electronic device. However, the program product is not limited thereto. In this specification, the readable storage medium may be any tangible medium that includes or stores a program. The program may be used by or in combination with a command execution system, apparatus, or device.

The readable signal medium may include a data signal propagated in a baseband or as a part of a carrier, and carries the readable computer program. A data signal propagated in such a way may assume a plurality of forms, including, but not limited to, an electromagnetic signal, an optical signal, or any appropriate combination thereof. The readable signal medium may be any readable medium other than a readable storage medium, and the readable medium may send, propagate, or transmit a program used by or in combination with a command execution system, apparatus, or device.

The computer program included in the readable medium may be transmitted by using any suitable medium, including but not limited to a wireless medium, a wired medium, an optical cable, a radio frequency (RF), or the like, or any appropriate combination thereof.

The computer program configured for executing the operations may be written by using any combination of one or more programming languages. The programming languages include object-oriented programming languages such as Java and C++, and also include a conventional procedural programming language like “C” or a similar programming language. The computer program may be completely executed on a user electronic device, partially executed on a user electronic device, executed as an independent software package, partially executed on a user electronic device and partially executed on a remote electronic device, or completely executed on a remote electronic device or server. In a case involving the remote electronic device, the remote electronic device may be connected to the user electronic device through any type of network including a local area network (LAN) or a wide area network (WAN), or may be connected to an external electronic device (for example, which may be connected through the internet by using an internet service provider).

Although several units or subunits of the apparatus are mentioned in the foregoing detailed descriptions, such division is merely exemplary and not mandatory. In fact, according to one or more embodiments, features and functions of two or more units described above may be specified in one unit. On the contrary, the features or functions of one unit described above may further be divided and specified in a plurality of units.

In addition, although the operations of the method are described in a specific order in the accompanying drawings, this does not require or imply that the operations are bound to be executed in the specific order, or all the operations shown are bound to be executed to achieve the expected result. Additionally or alternatively, some operations may be omitted, a plurality of operations may be combined into one operation for execution, and/or one operation may be decomposed into a plurality of operations for execution.

Persons skilled in the art are to understand that one or more embodiments may be provided as a method, a system, or a computer program product. Therefore, this disclosure may use a form of hardware-only embodiments, software-only embodiments, or embodiments combining software and hardware. Moreover, one or more embodiments may use a form of a computer program product that is implemented on one or more computer-usable storage media (including but not limited to a disk memory, a CD-ROM, and an optical memory) that include a computer-usable computer program.

The disclosure is described with reference to flowcharts and/or block diagrams of the method, the device (system), and the computer program product according to one or more embodiments. Computer program commands can implement each procedure and/or block in the flowcharts and/or block diagrams and a combination of procedures and/or blocks in the flowcharts and/or block diagrams. These computer program commands may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using commands executed by a computer or a processor of another programmable data processing device.

These computer program commands may also be stored in a computer-readable memory that can guide a computer or another programmable data processing device to work in a specific manner, so that the commands stored in the computer-readable memory generate an artifact that includes a command apparatus, and the command apparatus implements a specified function in one or more procedures in the flowcharts and/or in one or more blocks in the block diagrams.

These computer program commands may be loaded onto a computer or another programmable data processing device, so that a series of operating operations are performed on the computer or the another programmable device, thereby generating computer-implemented processing. Therefore, the commands executed on the computer or the another programmable device provide operations for implementing a specified function in one or more procedures in the flowcharts and/or in one or more blocks in the block diagrams.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An ambient light compensation method, performed by an electronic device, and comprising:
shooting an environment image based on a distance between an object and a distance sensor being less than a preset threshold;
determining an original light color and a color cast value of a current ambient light based on color information in the environment image, the color cast value representing a color distribution status of the original light color in a color gamut;
determining, based on the original light color and a target light color of a target ambient light, a compensation light color corresponding to the current ambient light;
determining a light lightness adjustment parameter based on the compensation light color and the color cast value; and
performing light compensation on the current ambient light based on the light lightness adjustment parameter.

2. The ambient light compensation method according to claim 1, wherein the color information comprises a plurality of pieces of color channel information, and
wherein determining the original light color of the current ambient light based on the color information in the environment image comprises:
dividing the environment image into a plurality of image areas;
determining, based on the plurality of pieces of color channel information of pixels in each image area of the plurality of image areas, a local color temperature value corresponding to each image area of the plurality of image areas; and
determining, based on the local color temperature values respectively corresponding to the plurality of image areas, an overall color temperature value corresponding to the environment image, the overall color temperature value representing the original light color.

3. The ambient light compensation method according to claim 2, wherein determining the color cast value of the current ambient light based on the color information in the environment image comprises:
determining, based on a difference that is between a plurality of color channels and that is of the plurality of pieces of color channel information of the pixels in each image area of the plurality of image areas, a local color cast value corresponding to each image area of the plurality of image areas; and
determining the color cast value of the current ambient light based on the local color cast values respectively corresponding to the plurality of image areas.

4. The ambient light compensation method according to claim 2, wherein determining the compensation light color corresponding to the current ambient light comprises:
determining a compensation color temperature value based on a difference between the overall color temperature value and a target color temperature value corresponding to the target light color, the compensation color temperature value representing the compensation light color.

5. The ambient light compensation method according to claim 3, wherein determining the light lightness adjustment parameter based on the compensation light color and the color cast value comprises:
determining a compensation ratio based on the local color cast values; and
determining the light lightness adjustment parameter based on the compensation ratio and a compensation color temperature value corresponding to the compensation light color, the compensation color temperature value being determined based on the overall color temperature value and a target color temperature value corresponding to the target light color.

6. The ambient light compensation method according to claim 1, further comprising:
determining, based on color information of each pixel in the environment image, at least one of a pixel color temperature value or a pixel color cast value corresponding to each pixel in the environment image;
aggregating pixels belonging to a same interval into a pixel group based on at least one of the pixel color temperature value and predetermined color temperature value intervals, or the pixel color cast value and predetermined color cast value intervals; and
determining a reference light color of the current ambient light based on a quantity of the pixels in each pixel group and a color classification corresponding to each pixel group; and
wherein the determining, based on the original light color and the target light color of target ambient light, the compensation light color corresponding to the current ambient light comprises:
determining the compensation light color based on the reference light color, the original light color, and the target light color.

7. The ambient light compensation method according to claim 1, further comprising:
periodically detecting ambient light to obtain the original light color, the compensation light color, and the light lightness adjustment parameter at each detection moment; and
adjusting the light lightness adjustment parameter and the compensation light color at a current detection moment based on a difference between the original light color at the current detection moment and the original light color at a previous detection moment.

8. An ambient light compensation apparatus, comprising:
at least one memory configured to store program code; and
at least one processor configured to read the program code and operate as instructed by the program code, the program code comprising:
shooting code configured to cause at least one of the at least one processor to shoot an environment image based on a distance between an object and a distance sensor being less than a preset threshold;
first determining code configured to cause at least one of the at least one processor to determine an original light color and a color cast value of a current ambient light based on color information in the environment image, the color cast value representing a color distribution status of the original light color in a color gamut;
second determining code configured to cause at least one of the at least one processor to determine, based on the original light color and a target light color of a target ambient light, a compensation light color corresponding to the current ambient light;
third determining code configured to cause at least one of the at least one processor to determine a light lightness adjustment parameter based on the compensation light color and the color cast value; and
compensation code configured to cause at least one of the at least one processor to perform light compensation on the current ambient light based on the light lightness adjustment parameter.

9. The ambient light compensation apparatus according to claim 8, wherein the color information comprises a plurality of pieces of color channel information, and
wherein the first determining code is further configured to cause at least one of the at least one processor to:
divide the environment image into the plurality of image areas;
determine, based on the plurality of pieces of color channel information of pixels in each image area, a local color temperature value corresponding to each image area of the plurality of image areas; and
determine, based on the local color temperature values respectively corresponding to the plurality of image areas, an overall color temperature value corresponding to the environment image, the overall color temperature value representing the original light color.

10. The apparatus according to claim 9, wherein the first determining code is further configured to cause at least one of the at least one processor to:
determine, based on a difference that is between a plurality of color channels and that is of the plurality of pieces of color channel information of the pixels in each image area of the plurality of image areas, a local color cast value corresponding to each image area of the plurality of image areas; and
determine the color cast value of the current ambient light based on the local color cast values respectively corresponding to the plurality of image areas.

11. The ambient light compensation apparatus according to claim 9, wherein the second determining code is further configured to cause at least one of the at least one processor to determine a compensation color temperature value based on a difference between the overall color temperature value and a target color temperature value corresponding to the target light color, the compensation color temperature value representing the compensation light color.

12. The ambient light compensation apparatus according to claim 10, wherein the third determining code is further configured to cause at least one of the at least one processor to:
determine a compensation ratio based on the local color cast values; and
determine the light lightness adjustment parameter based on the compensation ratio and a compensation color temperature value corresponding to the compensation light color, the compensation color temperature value being determined based on the overall color temperature value and a target color temperature value corresponding to the target light color.

13. The ambient light compensation apparatus according to claim 8, wherein
the first determining code is further configured to cause at least one of the at least one processor to:
determine, based on color information of each pixel in the environment image, at least one of a pixel color temperature value or a pixel color cast value corresponding to each pixel in the environment image;
aggregate pixels belonging to a same interval into a pixel group based on at least one of the pixel color temperature value and predetermined color temperature value intervals, or the pixel color cast value and predetermined color cast value intervals; and
determine a reference light color of the current ambient light based on a quantity of the pixels in each pixel group and a color classification corresponding to each pixel group; and
the second determining code is further configured to cause at least one of the at least one processor to determine the compensation light color based on the reference light color, the original light color, and the target light color.

14. The ambient light compensation apparatus according to claim 8, further comprising:
adjustment code configured to cause at least one of the at least one processor to:
periodically detect ambient light to obtain the original light color, the compensation light color, and the light lightness adjustment parameter at each detection moment; and
adjust the light lightness adjustment parameter and the compensation light color at a current detection moment based on a difference between the original light color at the current detection moment and the original light color at a previous detection moment.

15. A non-transitory computer-readable storage medium, storing computer code which, when executed by at least one processor, causes the at least one processor to at least:
shoot an environment image based on a distance between an object and a distance sensor being less than a preset threshold;
determine an original light color and a color cast value of a current ambient light based on color information in the environment image, the color cast value representing a color distribution status of the original light color in a color gamut;
determine, based on the original light color and a target light color of a target ambient light, a compensation light color corresponding to the current ambient light;
determine a light lightness adjustment parameter based on the compensation light color and the color cast value; and
perform light compensation on the current ambient light based on the light lightness adjustment parameter.

16. The non-transitory computer-readable storage medium according to claim 15, wherein the color information comprises a plurality of pieces of color channel information, and
wherein the determine the original light color of the current ambient light based on the color information in the environment image comprises:
dividing the environment image into a plurality of image areas;
determining, based on the plurality of pieces of color channel information of pixels in each image area of the plurality of image areas, a local color temperature value corresponding to each image area of the plurality of image areas; and
determining, based on the local color temperature values respectively corresponding to the plurality of image areas, an overall color temperature value corresponding to the environment image, the overall color temperature value representing the original light color.

17. The non-transitory computer-readable storage medium according to claim 16, wherein the determine the color cast value of the current ambient light based on the color information in the environment image comprises:
determining, based on a difference that is between a plurality of color channels and that is of the plurality of pieces of color channel information of the pixels in each image area of the plurality of image areas, a local color cast value corresponding to each image area of the plurality of image areas; and
determining the color cast value of the current ambient light based on the local color cast values respectively corresponding to the plurality of image areas.

18. The non-transitory computer-readable storage medium according to claim 16, wherein the determine the compensation light color corresponding to the current ambient light comprises:
determining a compensation color temperature value based on a difference between the overall color temperature value and a target color temperature value corresponding to the target light color, the compensation color temperature value representing the compensation light color.

19. The non-transitory computer-readable storage medium according to claim 17, wherein the determine the light lightness adjustment parameter based on the compensation light color and the color cast value comprises
determining a compensation ratio based on the local color cast values; and
determining the light lightness adjustment parameter based on the compensation ratio and a compensation color temperature value corresponding to the compensation light color, the compensation color temperature value being determined based on the overall color temperature value and a target color temperature value corresponding to the target light color.

20. The non-transitory computer-readable storage medium according to claim 15, wherein the computer code, when executed by the at least one processor, further causes the at least one processor to at least:
determine, based on color information of each pixel in the environment image, at least one of a pixel color temperature value or a pixel color cast value corresponding to each pixel in the environment image;
aggregate pixels belonging to a same interval into a pixel group based on at least one of the pixel color temperature value and predetermined color temperature value intervals, or the pixel color cast value and predetermined color cast value intervals; and
determining a reference light color of the current ambient light based on a quantity of the pixels in each pixel group and a color classification corresponding to each pixel group, and
wherein the determine the compensation light color corresponding to the current ambient light comprises:
determining the compensation light color based on the reference light color, the original light color, and the target light color.
